(19) United States
(12) Patent Application Publication
(10) Pub. No.: US 2025/0033557 A1
(43) Pub. Date: Jan. 30, 2025

(54) Temporary Truck-Trailer Replacement Light Device

(71) Applicant: Gerald Wayne Corbin, San Jose, CA (US)

(72) Inventor: Gerald Wayne Corbin, San Jose, CA (US)

(21) Appl. No.: 18/426,867

(22) Filed: Jan. 30, 2024

Related U.S. Application Data
(60) Provisional application No. 63/528,959, filed on Jul. 26, 2023.

(51) Int. Cl. B60Q 1/30; B60Q 1/26

(52) U.S. Cl. CPC B60Q 1/305; B60Q 1/2615; B60Q 1/2626

(57) ABSTRACT

A temporary truck-trailer replacement light device is provided. The device is comprised of a base that may easily be secured to the rear end of a trailer. A light on the device may be turned on to illuminate the rear end of the trailer if a trailer light malfunctions and is unable to provide light, signaling to other drivers the presence of the vehicle and making the roadways safer.

### CROSS-REFERENCE TO RELATED APPLICATION

The present application claims priority to, and the benefit of, U.S. Provisional Application No. 63/528,959, which was filed on Jul. 26, 2023, and is incorporated herein by reference in its entirety.

### FIELD OF THE INVENTION

The present invention relates generally to the field of vehicle lights. More specifically, the present invention relates to a temporary truck-trailer replacement light device comprised of a base that may easily be secured to the rear end of a trailer. A light on the device may be turned on to illuminate the rear end of the trailer if a trailer light malfunctions and is unable to provide light, signaling to other drivers the presence of the vehicle and making the roadways safer. Accordingly, the present disclosure makes specific reference thereto. Nonetheless, it is to be appreciated that aspects of the present invention are also equally applicable to other like applications, devices, and methods of manufacture.

### BACKGROUND

When a trailer light malfunctions, it often results in a situation that is not only time-consuming but also incredibly challenging to rectify, particularly during the early morning or late evening hours when visibility is diminished and the functionality of such lights is critical. The absence of a working trailer light can significantly increase the peril to other road users, potentially leading to hazardous driving conditions. Moreover, operating a vehicle with a defective trailer light can draw the attention of law enforcement, thereby exposing the driver to the risk of traffic infractions. This could lead to the imposition of fines, which are not only financially burdensome but also consume valuable time

Therefore, there exists a long-felt need in the art for a device that can temporarily replace the light of a truck trailer. More specifically, there exists a long-felt need in the art for a temporary truck-trailer replacement light device that can be easily secured to the rear end of a trailer to provide light in the event that a trailer light malfunctions. Furthermore, there exists a long-felt need in the art for a temporary truck-trailer replacement light device that can illuminate the rear end of a trailer to signal to other drivers on the road that there is a vehicle during lowlight hours of the day or night.

The subject matter disclosed and claimed herein, in one embodiment thereof, comprises a temporary truck-trailer replacement light device. The device is comprised of a base that may easily be secured to the rear end of a trailer. A light on the device may be turned on to illuminate the rear end of the trailer if a trailer light malfunctions and is unable to provide light, signaling to other drivers the presence of the vehicle and making the roadways safer.

In this manner, the temporary truck-trailer replacement light device of the present invention accomplishes all the foregoing objectives and provides a device that can temporarily replace the light of a truck trailer. More specifically, the temporary truck-trailer replacement light device can be secured to the rear end of a trailer to provide light if a trailer light malfunctions. Furthermore, the temporary truck-trailer replacement light device can signal to other drivers on the road that there is a vehicle during lowlight hours of the day or night.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a temporary truck-trailer replacement light device primarily comprised of a base, a light, and a charging structure. The device is designed to be secured to the rear end of a truck trailer when one or more of the trailer lights malfunctions to indicate to other drivers on the road that a vehicle is there.

The device is comprised of a generally rectangular base made from a reflective material. The base may be further comprised of a fastener that allows the device to be secured to the rear end of a trailer. The device is further comprised of a light that may be illuminated by pressing a button of the device. The light may illuminate continuously or intermittently such that the light flashes in differing embodiments. The light may be powered by at least one battery that may receive power via a charging structure in the form of a charging port or a solar panel in differing embodiments.

The present invention is also comprised of a method of using the device. First, a device is provided comprised of a base, a light, and a charging structure. Then, the base of the device may be stuck onto a trailer via at least one fastener in the form of an adhesive. Then, the button may be pressed to turn the light of the device on.

The present invention is also comprised of a second method of using the device. First, a device is provided comprised of a base, a light, and a charging structure. Then, the base of the device may be secured to a trailer by screwing at least one fastener through at least one opening of the base and into the trailer. Then, the button may be pressed to turn the light of the device on.

Accordingly, the temporary truck-trailer replacement light device of the present invention is particularly advantageous as it provides a device that can temporarily replace the light of a truck trailer. More specifically, the temporary truck-trailer replacement light device can provide a signal to other drivers on the road that a vehicle is there during lowlight hours of the day or night. Furthermore, the temporary truck-trailer replacement light device can be easily secured to the rear end of a trailer to provide light if a trailer light malfunctions. In this manner, the temporary truck-trailer replacement light device provides a solution to temporarily repair broken truck-trailer lights.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a temporary truck-trailer replacement light device of the present invention in accordance with the disclosed architecture;

FIG. 2 illustrates a bottom view of one potential embodiment of a temporary truck-trailer replacement light device of the present invention in accordance with the disclosed architecture;

FIG. 3 illustrates a perspective view of one potential embodiment of a temporary truck-trailer replacement light device of the present invention while attached to a trailer in accordance with the disclosed architecture;

FIG. 4 illustrates a flowchart of a method of using one potential embodiment of a temporary truck-trailer replacement light device of the present invention in accordance with the disclosed architecture; and

FIG. 5 illustrates a flowchart of a method of using one potential embodiment of a temporary truck-trailer replacement light device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that can temporarily replace the light of a truck trailer. More specifically, there exists a long-felt need in the art for a temporary truck-trailer replacement light device that can be easily secured to the rear end of a trailer to provide light in the event that a trailer light malfunctions. Furthermore, there exists a long-felt need in the art for a temporary truck-trailer replacement light device that can illuminate the rear end of a trailer to signal to other drivers on the road that there is a vehicle during lowlight hours of the day or night.

The present invention, in one exemplary embodiment, is comprised of a temporary truck-trailer replacement light device. The device is primarily comprised of a base, a light, and a charging structure. The device is designed to be secured to the rear end of a truck trailer when one or more of the trailer lights malfunctions to indicate to other drivers on the road that a vehicle is there.

More specifically, the device is comprised of a generally rectangular base that may be made from any reflective material. The base may be further comprised of a bottom surface that is further comprised of an at least one fastener that allows the device to be secured to the rear end of a trailer. The fastener may be any fastener known in the art. In one potential embodiment, the base may be comprised of at least one opening in which the fastener may be passed through to secure the device to the trailer.

The device is further comprised of a light that may be any general automotive light color. Further, the light may be a continuous illumination or could flash incrementally in differing embodiments. The light may be controlled via at least one button that may turn the light on or off. The light may be powered by at least one battery. In one potential embodiment, the battery may be non-removable such that the battery may be charged via a charging structure. The charging structure may be a solar panel or charging port, such as a USB port, in differing embodiments. In another embodiment of the device, the battery may simply be removable and be replaced with standard sizes of disposable batteries.

The present invention is also comprised of a method of using the device. First, a device is provided comprised of a base, a light, and a charging structure. Then, the base of the device may be stuck onto a trailer via at least one fastener in the form of an adhesive. Then, the button may be pressed to turn the light of the device on.

The present invention is also comprised of a second method of using the device. First, a device is provided comprised of a base, a light, and a charging structure. Then, the base of the device may be secured to a trailer by screwing at least one fastener through at least one opening of the base and into the trailer. Then, the button may be pressed to turn the light of the device on.

Accordingly, the temporary truck-trailer replacement light device of the present invention is particularly advantageous as it provides a device that can temporarily replace the light of a truck trailer. More specifically, the temporary truck-trailer replacement light device can be secured to the rear end of a trailer easily to temporarily act as a trailer light if the existing trailer light malfunctions. Furthermore, the temporary truck-trailer replacement light device can signal to other drivers on the road the presence of a vehicle. In this manner, the temporary truck-trailer replacement light device provides a solution to temporarily repair broken truck-trailer lights.

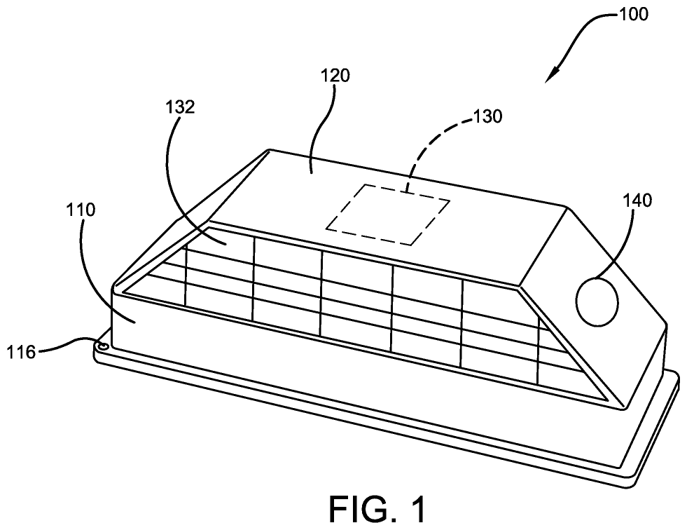

Referring initially to the drawings, FIG. 1 illustrates a perspective view of one potential embodiment of a temporary truck-trailer replacement light device 100 of the present invention in accordance with the disclosed architecture. The device 100 is primarily comprised of a base 110, a light 120, and a charging structure 132. The device 100 is designed to be secured to the rear end (or other area) of a truck-trailer 10, vehicle trailer, etc., when one or more of the trailer lights malfunctions to indicate to other drivers on the road that a vehicle is there.

The device 100 is comprised of a base 110 that is preferably generally rectangular in shape but may be any shape that generally resembles a brake light, such as a square, an oval, a circle, etc. The base 110 may further be made from any material commonly used to make brake lights, such as, but not limited to, a polycarbonate material or an acrylic. The base 110 is preferably made from a reflective material to improve visibility.

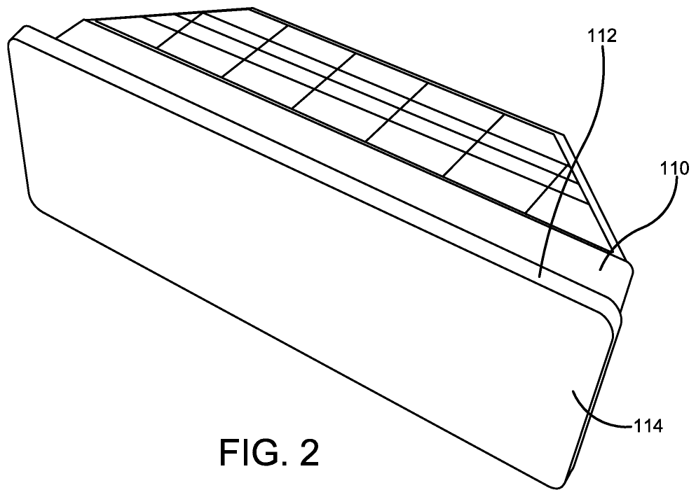

The base 110 may be further comprised of a bottom surface 112, as best seen in FIG. 2. The bottom surface 112 may be further comprised of at least one fastener 114 that may allow the device 100 to be easily secured to a trailer 10 such as, but not limited to, a semi-truck trailer, a towing trailer, etc. In one potential embodiment, the base 110 may be further comprised of at least one opening 116. At least one fastener 114 may be passed through to secure the device 100 to the trailer 10. The fastener 114 may be any fastener known in the art such as, but not limited to, an adhesive, a screw, a bolt, a nail, a hook-and-loop fastener, a glue, a tape, a press-fit fastener, etc.

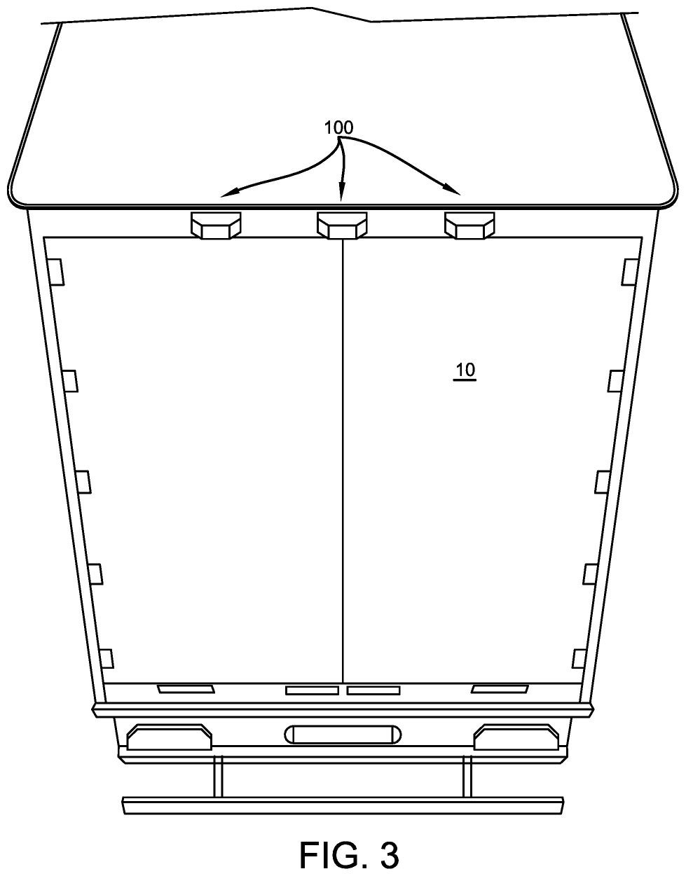

FIG. 3 illustrates a perspective view of one potential embodiment of a temporary truck-trailer replacement light device 100 of the present invention while attached to a trailer 10 in accordance with the disclosed architecture. The device 100 is further comprised of at least one light 120 attached to the base 110. The light 120 may be any type of light known in the art, but is preferably an LED light. The light 120 may be any general automotive light color, such as, but not limited to, red, orange, yellow, amber, white, etc. Further, the function of the light 120 may be any pattern such that it remains illuminated continuously while turned on or flashes incrementally in differing embodiments. The light 120 may be turned on by the pressing of a button 140. The button 140 may be a singular button to turn the light 120 on/off or a controller that allows for customization of illumination pattern, illumination speed, brightness, color, etc.

The light 120 may be powered by a battery 130. In one potential embodiment, the battery 130 may be non-removable such that the battery 130 may be charged via a charging structure 132. The charging structure 132, in differing embodiments, may be any power-receiving structure, such as, but not limited to, a solar panel, a charging port, an outlet adapter, etc. In another potential embodiment of the device 100, the battery 130 may be removable such that the battery 130, once dead, may be removed and replaced with another like battery 130.

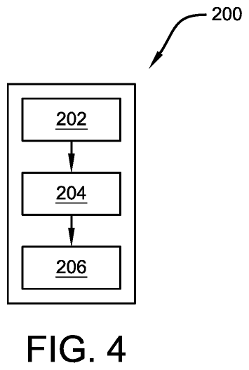

The present invention is also comprised of a method 200 of using the device 100, as seen in FIG. 4. First, a device 100 is provided comprised of a base 110, a light 120, a battery 130, and a charging structure 132 [Step 202]. Then, the base 110 of the device 100 may be attached to a trailer 10 via at least one fastener 114 in the form of, but not limited to, an adhesive [Step 204]. Then, the button 140 may be pressed to turn the light 120 of the device 100 on and select an illumination pattern, brightness, color, etc. [Step 206].

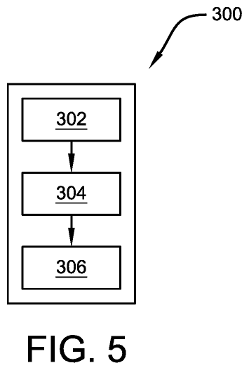

The present invention is also comprised of a second method 300 of using the device 10, as seen in FIG. 5. First, a device 100 is provided comprised of a base 110, a light 120, a battery 130, and a charging structure 132 [Step 302]. Then, the base 110 of the device 100 may be secured to a trailer 10 by screwing at least one fastener 114 through at least one opening 116 of the base 110 and into the trailer 10 [Step 304]. Then, the button 140 may be pressed to turn the light 120 of the device 100 on and select an illumination pattern, brightness, color, etc. [Step 306].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “temporary truck-trailer replacement light device” and “device” are interchangeable and refer to the temporary truck-trailer replacement light device 100 of the present invention.

Notwithstanding the foregoing, the temporary truck-trailer replacement light device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the temporary truck-trailer replacement light device 100 as shown in the FIGS. are for illustrative purposes only, and that many other sizes and shapes of the temporary truck-trailer replacement light device 100 are well within the scope of the present disclosure. Although the dimensions of the temporary truck-trailer replacement light device 100 are important design parameters for user convenience, the temporary truck-trailer replacement light device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A temporary truck-trailer replacement light device comprising:
a base comprised of a fastener;
a light attached to the base;
a button; and
a battery.

2. The temporary truck-trailer replacement light device of claim 1, wherein the base is comprised of a reflective material.

3. The temporary truck-trailer replacement light device of claim 1, wherein the light is comprised of a red light, an orange light, a yellow light, an amber light, or a white light.

4. The temporary truck-trailer replacement light device of claim 1, wherein the light flashes.

5. The temporary truck-trailer replacement light device of claim 1, wherein the light continuously illuminates.

6. The temporary truck-trailer replacement light device of claim 1, wherein the fastener is positioned on a bottom surface of the base.

7. The temporary truck-trailer replacement light device of claim 6, wherein the fastener is comprised of an adhesive fastener.

8. A temporary truck-trailer replacement light device comprising:
a base comprised;
a light attached to the base;
a button;
a battery; and
a charging structure.

9. The temporary truck-trailer replacement light device of claim 8, wherein the charging structure is comprised of a charging port.

10. The temporary truck-trailer replacement light device of claim 8, wherein the charging structure is comprised of a solar panel.

11. The temporary truck-trailer replacement light device of claim 8, wherein the base is comprised of an opening.

12. The temporary truck-trailer replacement light device of claim 8 further comprised of a fastener.

13. The temporary truck-trailer replacement light device of claim 12, wherein the fastener is comprised of a screw.

14. The temporary truck-trailer replacement light device of claim 8, wherein the light flashes.

15. The temporary truck-trailer replacement light device of claim 8, wherein the light continuously illuminates.

16. The temporary truck-trailer replacement light device of claim 8, wherein the button controls the light.

17. A method of using a temporary truck-trailer replacement light device, the method comprising the following steps:
providing a temporary truck-trailer replacement light device comprised of a base, a light, and a battery;
attaching the base to a truck-trailer via a fastener; and
turning on the light via a button of the temporary truck-trailer replacement light device.

18. The method of using a temporary truck-trailer replacement light device of claim 17, wherein the base is comprised of an opening.

19. The method of using a temporary truck-trailer replacement light device of claim 18 further comprising a step of placing the fastener through the opening and into the truck-trailer.

20. The method of using a temporary truck-trailer replacement light device of claim 17, wherein the temporary truck-trailer replacement light device is comprised of a charging structure.
